(19) United States
(12) Patent Application Publication
(10) Pub. No.: US 2025/0225000 A1
(43) Pub. Date: Jul. 10, 2025

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventor: KOHEI IWABUCHI, Kanagawa (JP)

(21) Appl. No.: 18/981,973

(22) Filed: Dec. 16, 2024

(30) Foreign Application Priority Data
Jan. 10, 2024 (JP) 2024-001644

(51) Int. Cl. G06F 9/50

(52) U.S. Cl. CPC G06F 9/5088

(57) ABSTRACT

An information processing device that determines a second device which takes over execution of a first task from a first device for executing the first task and which executes a second task different from the first task performs: detecting that the first task is a handover target; acquiring handover target task information on the first task; acquiring handover partner candidate information on candidates for the second device; acquiring an additional time required for executing the first task when the first task is handed over and executed for each candidate for the second device on the basis of the handover target task information and the handover partner candidate information; and determining the second device to which the first task is handed over out of the candidates for the second device on the basis of the additional times.

### BACKGROUND OF THE INVENTION

### Field of the Invention

The present invention relates to an information processing device, an information processing method, and a storage medium.

### Description of the Related Art

A plurality of robots of which each performs a given task may operate in work spaces adjacent to each other. However, there is a likelihood that a certain robot will not continue to perform a task due to reasons such as failure and a decrease of a battery voltage.

Japanese Unexamined Patent Publication No. 2021-43520 discloses a configuration for handing over a task which has been performed by a first robot to a second robot when the first robot is not likely to complete the task.

In the technique disclosed in Japanese Unexamined Patent Publication No. 2021-43520, there is a problem in that work efficiency of a plurality of robots as a whole decreases.

### SUMMARY OF THE INVENTION

According to an aspect of the present invention, there is provided an information processing device that determines a second device which takes over execution of a first task from a first device for executing the first task and which executes a second task different from the first task, the information processing device including:
one or more memories storing instructions; and
one or more processors executing the instructions to:
   detect that the first task is a handover target;
   acquire handover target task information on the first task;
   acquire handover partner candidate information on candidates for the second device;
   acquire an additional time required for executing the first task when the first task is handed over to and executed for each candidate for the second device on the basis of the handover target task information and the handover partner candidate information; and
   determine the second device to which the first task is handed over out of the candidates for the second device on the basis of the additional times.

Further features of the present invention will become apparent from the following description of embodiments with reference to the attached drawings.

### BRIEF DESCRIPTION OF THE DRAWINGS

FIG. 1 is a diagram illustrating an example of a situation in which an information processing device according to a first embodiment of the present invention is used.

FIG. 2 is a diagram illustrating an example of a hardware configuration of the information processing device according to the first embodiment.

FIG. 3 is a functional block diagram illustrating an example of a configuration of the information processing device according to the first embodiment.

FIG. 4 is a diagram illustrating an example of a task table that is used for the information processing device according to the first embodiment to manage tasks.

FIG. 5 is a diagram illustrating an example of a robot information table 500 that is used for the information processing device according to the first embodiment to manage robots for performing tasks.

FIG. 6 is a flowchart illustrating an example of a process flow of determining a handover partner in an information processing method according to the first embodiment.

FIGS. 7A to 7C are diagrams illustrating examples of a screen 700 of an information processing device according to a fifth embodiment.

FIGS. 8A and 8B are diagrams illustrating examples of a screen for additionally displaying a determination result of a handover partner on the screen illustrated in FIGS. 7A to 7C.

FIGS. 9A and 9B are diagrams illustrating examples of a screen for additionally displaying an execution state of a robot on the screen illustrated in FIGS. 7A to 7C.

FIGS. 10A to 10C are diagrams illustrating examples of a screen for additionally displaying a scheduled completion time of a handover target task on the screen illustrated in FIGS. 7A to 7C.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

In a first embodiment, an example in which a second robot which is a second device to which a first task performed up to now by a first robot which is a first device is handed over is determined on the basis of predetermined conditions when the first robot cannot continue to perform the first task will be described.

That is, an information processing device in the following description performs an information processing method of determining a second device that performs a second task which is different from a first task and to which a first task is handed over from a first device that performs the first task.

Robots will be exemplified in the present embodiment, but autonomous mobile objects such as an automated guided vehicle (AGV) or an autonomous mobile robot (AMR) may be employed instead of robots. For example, mobile objects such as a vehicle and a drone for carrying persons or luggage may be employed.

In the present embodiment, by calculating a time which is additionally required for handover for each robot which may be used as the second robot and selecting a robot with the shortest time, a decrease in efficiency due to the handover is minimized.

First, terms which are used in the present embodiment are defined. A handover source is a robot which cannot continue to perform a task and which hands over the task to another robot for the purpose of execution thereof. A handover target task is a task which has been executed by the handover source.

A handover partner is a robot to which a handover target task is handed over and which executes the handover target task. A handover partner candidate is a set of robots which are to be a handover partner. An interrupt task is a task which has been performed by a handover partner. The handover partner interrupts a task under execution (an interrupt task) and takes over and executes a handover target task.

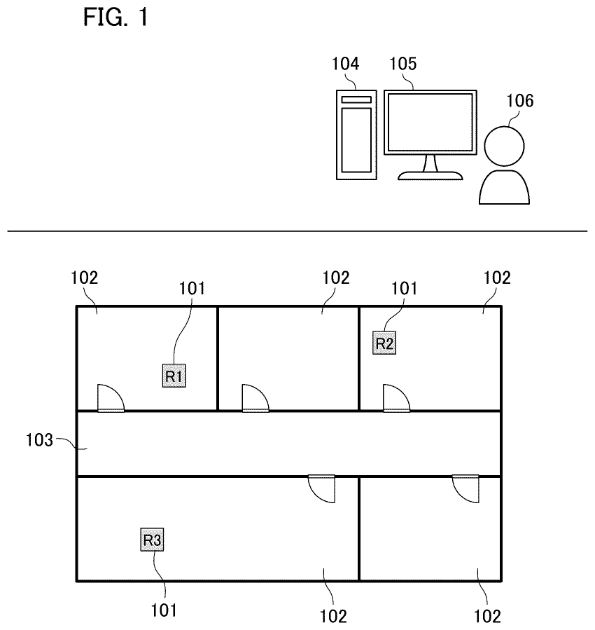

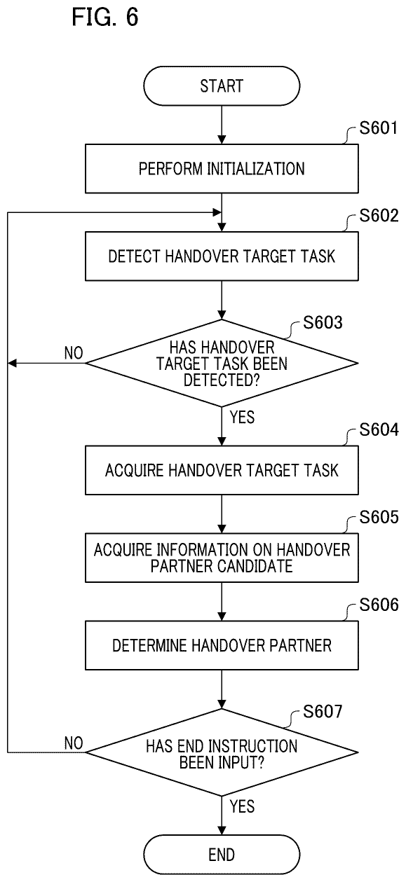

FIG. 1 is a diagram illustrating an example of a situation in which an information processing device according to the first embodiment of the present invention is used. Reference sign 101 denotes a robot that executes a task. Reference sign 102 denotes a room. Reference sign 103 denotes a passage connecting the rooms 102. Reference sign 104 denotes a computer that perform a process of determining a handover partner out of handover partner candidates which will be described later with reference to FIG. 6.

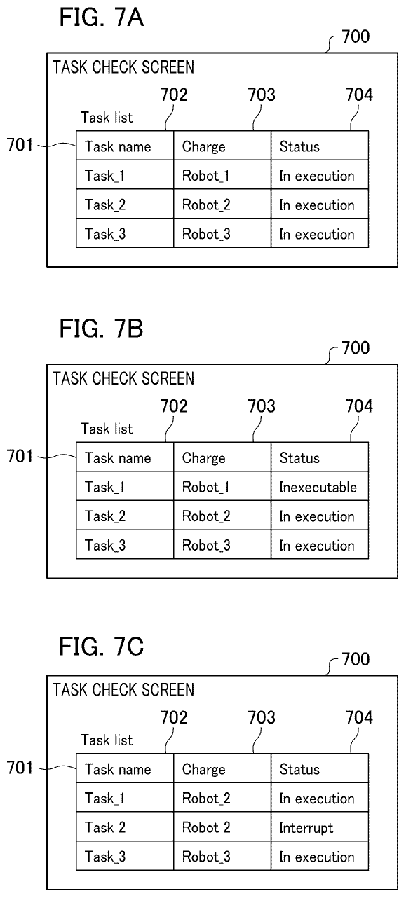

Reference sign 105 denotes a display that displays a screen which will be described later with reference to FIGS. 7A to 7C. Reference sign 106 denotes a user of the information processing device who ascertains a screen displayed on the display 105. Each robot 101 executes a task given to the robot. A task includes information on an execution place thereof. The execution place of a task is a predetermined range such as the room 102 or the passage 103.

The computer 104 monitors states of the robots 101 and displays execution statuses of tasks or the states of the robots on the display 105. The computer 104 detects that a first robot out of the robots 101 cannot continue to execute a task due to a reason such as a failure or a decrease in voltage of a battery.

The computer 104 determines a second robot which will take over and executes a task which has been executed by the first robot on the basis of the detection result and instructs the second robot to execute the task which has been executed by the first robot.

Information or the like indicating that the task which has been executed by the first robot will be handed over to the second robot is displayed in the screen displayed on the display 105. The user 106 ascertains the screen displayed on the display 105 and ascertains a process situation of the task or recovers a robot which is inoperable.

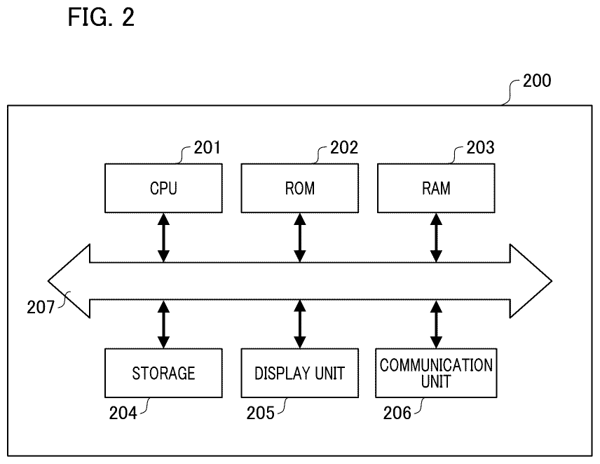

FIG. 2 is a diagram illustrating an example of a hardware configuration of the information processing device according to the first embodiment. The information processing device 200 includes a CPU 201 which is a computer, a ROM 202, a RAM 203, a storage 204, a display unit 205, and a communication unit 206, and these constituents are connected via a system bus 207.

The CPU 201 is a central processing unit and performs calculation for various processes, logical determination, and the like by executing a computer program stored in a storage medium. The CPU 201 controls the constituents connected to the system bus 207.

The ROM (read only memory) 202 is a program memory and stores a computer program for control in the CPU 201 including various processing sequences which are performed in the information processing device 200. The RAM (random access memory) 203 is used as a main memory or a temporary storage area such as a work area of the CPU 201.

The program memory may be realized by loading a program to the RAM 203 from an external storage device or the like connected to the information processing device 200. The storage 204 is an auxiliary storage device that stores electronic data or programs according to the present embodiment. A hard disk drive or a solid state drive is known as an example of the auxiliary storage device.

An external storage device may be used to play the same role. Here, the external storage device can be realized, for example, by a medium (a storage medium) and an external storage drive for accessing the medium. For example, a CD-ROM, a DVD, a USB memory, an MO, or a flash memory is known as such a medium.

The external storage device may be an external server device connected thereto via a network. The display unit 205 is, for example, a CRT display or a liquid crystal display and is a device that outputs information to a display screen.

The display unit 205 may be an external display unit connected to the information processing device 200 in a wired or wireless manner. The communication unit 206 performs interactive communication with another information processing device, a communication device, an external storage device, an external terminal, or the like in a wired or wireless manner using known communication technology.

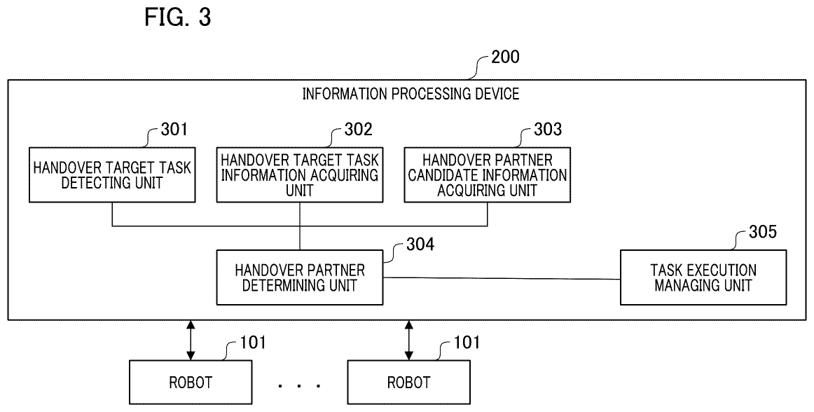

FIG. 3 is a functional block diagram illustrating an example of a configuration of the information processing device 200 according to the first embodiment. Some of the functional blocks illustrated in FIG. 3 are realized by causing the CPU 201 or the like which is a computer included in the information processing device to execute a computer program stored in a memory which is a storage medium.

Some or all of the functional blocks may be realized by hardware. A dedicated circuit (AIC), a processor (such as a reconfigurable processor or a DSP), or the like can be used as hardware. The functional blocks illustrated in FIG. 3 may not be incorporated into the same housing and may be constituted by different devices connected to each other via a signal line.

A handover target task detecting unit 301 serves as a handover target task detecting means and detects that a task which is a handover target (hereinafter referred to as a handover target task) has occurred, that is, that a first task is a handover target. The handover target task detecting unit 301 acquires states of robots using a task execution managing unit 305 which will be described later. A method of detecting that a handover target task has occurred from the states of robots will be described later with reference to FIG. 6.

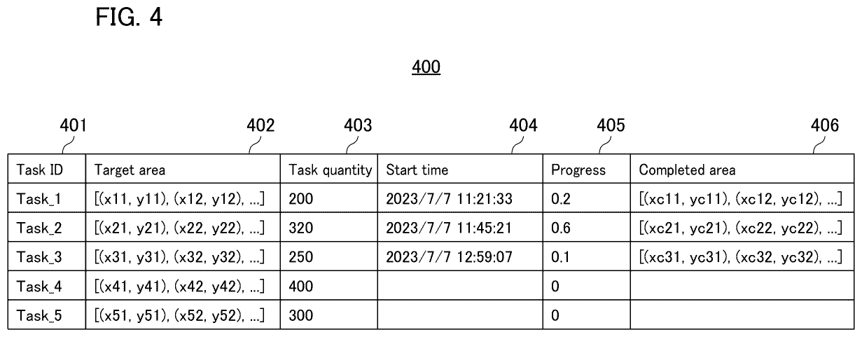

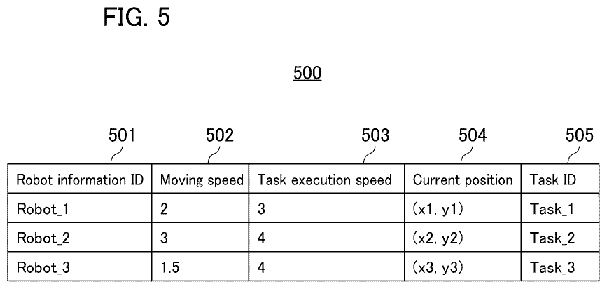

A handover target task information acquiring unit 302 serves as a handover target task information acquiring means and acquires information on a handover target task which is the first task. Details of the information on tasks including the handover target task will be described later with reference to FIG. 4. A handover partner candidate information acquiring unit 303 serves as a handover partner candidate information acquiring means and acquires information on handover partner candidates. Details of the information on robots including handover partner candidates will be described later with reference to FIG. 5.

A handover partner determining unit 304 determines a handover partner when the handover target task detecting unit 301 detects the handover target task. That is, the handover partner determining unit 304 determines a handover partner out of the handover partner candidates on the basis of the information acquired by the handover target task information acquiring unit 302 and the information acquired by the handover partner candidate information acquiring unit 303. Here, the handover partner determining unit 304 serves as an additional time acquiring means and a handover partner determining means.

A task execution managing unit 305 performs ascertainment of an operation status of each robot, allocation of tasks to the robots, and control of a task execution status of each robot via the communication unit 206. When a handover target task has occurred, the task execution managing unit 305 cancels allocation of a task to the handover source to stop execution of the task and allocates the handover target task to the handover partner determined by the information processing device 200 to restart execution thereof.

FIG. 4 is a diagram illustrating an example of a task table that is used for the information processing device according to the first embodiment to manage tasks. Each row in the task table 400 represents one task. An ID for uniquely identifying a task stored in the task table 400 is listed for each task ID 401.

A target area indicating a geometrical range in which the task identified by the task ID 401 is executed is listed as a target area 402. For example, regarding a task associated with cleaning, the target area 402 is a range in which cleaning is performed.

A task quantity which is a scale of the task identified by the task ID 401 is listed as a task quantity 403. A task with a larger task quantity 403 indicates that a time required for completion is longer. A time at which the task identified by the task ID 401 has started is listed as a start time 404. When the task has not started, nothing is described.

A progress of the task identified by the task ID 401 is listed as a progress 405. The progress 405 takes a real value between 0 and 1, where 0 indicates non-start and 1 indicates completion. The progress 405 is sequentially updated according to a degree of execution of the task.

An area in which execution of a task has been completed in the target area 402 is listed as a completed area 406. When the task has not started, nothing is described. The completed area 406 is sequentially updated according to the degree of execution of the task.

FIG. 5 is a diagram illustrating an example of a robot information table 500 that is used for the information processing device according to the first embodiment to manage robots for performing tasks. Each row in the robot information table 500 represents one piece of robot information.

An ID for uniquely identifying robot information stored in the robot information table 500 is listed as a robot information ID 501. A moving speed of a robot identified by the robot information ID 501 is listed as a moving speed 502.

A task execution speed indicating a speed at which the robot identified by the robot information ID 501 executes a task is listed as a task execution speed 503. The task execution speed is an index indicating a task quantity which is processed per unit time.

In the present embodiment, it is assumed that the robots execute the same type of tasks such as cleaning. However, when the robots can execute different types of tasks (for example, cleaning and luggage carrying), a task execution speed when each robot executes a task may be stored in the robot information table for each type of task.

Coordinate information indicating a current position of the robot identified by the robot information ID 501 is listed as a current position 504. The current position 504 is sequentially updated according to movement of the robot.

A task ID 401 of a task which is being executed by the robot identified by the robot information ID 501 is listed as a task ID 505. When the robot is not executing a task, nothing is listed as the task ID 505.

FIG. 6 is a flowchart illustrating an example of a process flow of determining a handover partner in an information processing method according to the first embodiment. Operations of steps in the flowchart illustrated in FIG. 6 are sequentially performed by causing a CPU which is a computer in the information processing device or the like to execute a computer program stored in a memory.

In Step S601, the CPU 201 loads a program to the RAM 203 from the storage 204 and performs an initialization process. In the initialization process, constants such as threshold values which are referred to in steps which will be described later are read.

In Step S602, the CPU 201 detects a handover target task using the handover target task detecting unit 301. Specifically, the CPU 201 acquires states of all robots and ascertains whether there is a robot corresponding to an inoperable state. When there is a robot corresponding to an inoperable state, a task which is being executed by the robot is the handover target task.

The inoperable state of a robot specifically means a state in which hardware of the robot is broken down, a state in which an error occurs in control software of the robot, a state in which a residual capacity of a battery of the robot is less than a predetermined threshold value, or the like. Here, Step S602 serves as a handover target task detecting step of detecting that a first task is a handover target using the handover target task detecting unit 301.

In Step S603, the CPU 201 determines whether the handover target task detecting unit 301 has detected a handover target task in Step S602. When a handover target task has been detected, the process of Step S604 is performed. When a handover target task has not been detected, the process of Step S602 is performed.

In Step S604, the CPU 201 acquires information on the handover target task using the handover target task information acquiring unit 302. Specifically, the CPU 201 searches for a corresponding row from the task table 400 using a task ID of a task (the handover target task) executed by the robot determined to be in an inoperable state in Step S602.

Accordingly, the CPU 201 acquires the target area 402, the task quantity 403, the progress 405, and the completed area 406. Here, Step S604 serves as a handover target task information acquiring step of acquiring handover target task information on a first task using the handover target task information acquiring unit 302.

In Step S605, the CPU 201 first acquires a list of handover partner candidates using the handover partner candidate information acquiring unit 303. Specifically, the CPU 201 acquires robot information of robots other than a handover source form the robot information table 500.

Then, information of each handover partner candidate is acquired. Specifically, the CPU 201 searches for a corresponding row in the robot information table 500 using the robot information ID 501 and acquires the moving speed 502, the task execution speed 503, and the current position 504. Here, Step S605 serves as a handover partner candidate information acquiring step of acquiring handover partner candidate information on candidates for the second device using the handover partner candidate information acquiring unit 303.

In Step S606, the CPU 201 determines a handover partner out of the handover partner candidates using the handover partner determining unit 304. Specifically, first, the CPU 201 calculates a time (hereinafter referred to as an additional time) which is additionally required when the handover target task is executed for each handover partner candidate.

Here, Step S606 serves as an additional time acquiring step. In Step S606, an additional time required for executing the first task when each candidate for the second device takes over and executes the first task is acquired on the basis of the handover target task information and the handover partner candidate information.

The additional time is calculated as a sum of a time which is required for movement to an execution place of a handover target task, a time which is required for execution of the handover target task, and a time which is required for movement to an execution place of an interrupt task (a time required for return to the interrupt task).

That is, the additional time includes at least a time which is required for the second device to move to the execution place of the first task and a time which is required for the second device to execute the first task. In the present embodiment, the additional time also includes a time which is required for the second device to return to the execution place of the second task.

The time required for movement to the execution place of the handover target task is calculated, for example, using Expression 1. An execution start position of the handover target task is the current position 504 of the handover source when a handover target task has occurred.

Robot information with the same task ID 505 or the same type of task ID 505 as the task ID of the handover target task is acquired from the robot information table 500, and the current position 504 is acquired from the robot information. |current position of handover partner candidate-execution start position of handover target task| is calculated as a distance detouring around an obstacle when the obstacle is present in the middle of movement.

Time required for movement to execution place of handover target task=|current position of handover partner candidate−execution start position of handover target task|/moving speed of handover partner candidate (Expression 1)

The time required for execution of the handover target task is calculated using Expression 2.

Time required for execution of handover target task=task quantity of handover target task*(1−progress of handover target task)/task execution speed of handover partner candidate (Expression 2)

The time required for movement (return) to the execution place of the interrupt task is calculated using Expression 3.

Time required for movement to execution place of interrupt task=|scheduled completion position of handover target task−current position of handover partner candidate|/moving speed of handover partner candidate (Expression 3)

The scheduled completion position of the handover target task is an estimated value of the current position 504 of the handover partner candidate when the handover target task has been completed. Here, the scheduled completion position of the handover target task is an estimated value of the current position 504 of the handover partner when the handover target task has been completed.

In order to calculate the estimated value, for example, a difference between the target area 402 and the completed area 406 of the handover target task is first calculated. The calculated difference is an uncompleted area of the handover target task. Then, for example, a gravitational center position of a path of the uncompleted area is set as a representative position. Alternatively, a coordinate position farthest from the current position 504 of the handover partner candidate in the uncompleted area may be set as the representative position.

This representative position is estimated to be a scheduled completion position of the handover target task. The current position of the handover source may be used as the estimated value of the scheduled completion position of the handover target task. |Scheduled completion position of handover target task−current position of handover partner candidate| is calculated as a distance detouring around an obstacle when the obstacle is present in the middle of movement.

Then, in Step S606, a handover partner candidate in which the additional time which is a sum of Expressions 1 to 3 is the shortest is determined as a handover partner. In this way, Step S606 serves as a handover partner determining step of determining the second position to which the first task is handed over out of the candidates for the second device on the basis of the additional time using the handover partner determining unit 304.

Instead of determining the handover partner candidate in which the additional time is the shortest as a handover partner, a candidate for the second device in which the calculated additional time is shorter may be more likely to be determined as the second device when the second device is determined out of the candidates for the second device. In addition, the second device which will be finally a handover partner may be determined according to the priority of the second task.

When the handover partner is determined, the task execution managing unit 305 allocates the handover target task to the handover partner. Specifically, the task ID 401 of the handover target task is set to the task ID 505 in the robot information corresponding to the handover partner. The value of the task ID 505 in the robot information corresponding to the handover source is deleted.

Then, in Step S607, the CPU 201 determines whether an end instruction from a user has been input. When an end instruction has been input, the process flow ends. When an end instruction has not been input, the process of Step S602 is performed.

As described above, in the present embodiment, when a handover target task occurs, a handover partner which takes over and executes the handover target task out of handover partner candidates is determined on the basis of the additional time. Accordingly, it is possible to enhance work efficiency of a plurality of robots as a whole.

### Modified Example 1

In the first embodiment, occurrence of a handover target task is detected using a method of acquiring a state of a robot and ascertaining whether the state of the robot corresponds to an inoperable state. Occurrence of a handover target task may be detected by ascertaining whether a robot holds resources required for execution of the task or ascertaining whether details of the task match attributes or a state of the robot.

When it is ascertained whether resources are held, for example, specifically, amounts of resources required for tasks which are being performed by all robots and amounts of resources currently held by the robots are acquired and compared.

When an amount of resources held by each robot is less than an amount of resources required for execution of a task, it is determined that a handover target task has occurred. The types of resources include, for example, a remaining charging capacity of a robot. Resources of a cleaning robot include a remaining detergent quantity and an available capacity of a garbage container.

When it is ascertained whether details of a task and attributes or a state of a robot match, specifically, surrounding environment information and attributes or a state of a robot are acquired, and it is ascertained whether factors hindering execution of the robot of the task is included in the surrounding environment.

For example, when environment information in which a robot has attributes of a “physique (size)” equal to or larger than a predetermined value and an object is placed in a passage which is too narrow to pass the robot is acquired, a robot with a smaller physique is necessary, and thus it is determined that a handover target task has occurred.

When environment information in which a robot has attributes of “vacuum cleaning is executable” and “rubbing cleaning is not executable” and a liquid is flooded onto a floor is acquired, there is an area in which a task cannot be executed by the robot. Accordingly, in this case, it is determined that a handover target task has occurred.

When environment information in which a robot has attributes of “no waterproof performance” and raining starts is acquired, the robot cannot continue to execute the task, and thus it is determined that a handover target task has occurred.

When environment information in which a sum of attributes of “weight” of a robot and a state of a “load weight” is equal to or greater than a predetermined value and congestion of the surroundings starts is acquired, the robot has difficulty continuously executing the task safely. Accordingly, in this case, it is determined that a handover target task has occurred.

### Modified Example 2

In the first embodiment, information indicating tasks is managed using the task table 400, and the types or expression forms of information indicating tasks are not limited to the method described above with reference to FIG. 4. In the first embodiment, the target area 402, the start time 404, and the completed area 406 are not necessary and may be excluded from management targets of the task table 400.

For example, the target area 402 and the completed area 406 are referred to for the purpose of calculation of an estimated value of a scheduled completion position of a handover target task when the time required for movement (return) to an execution place of the interrupt task is calculated. Accordingly, when a current position of a handover source is used as an estimated value of a scheduled completion position of a handover target task, the target area 402 and the completed area 406 are not necessary.

### Second Embodiment

In the first embodiment, an additional time is calculated for each handover partner candidate, and a handover partner candidate with the shortest additional time is determined as a handover partner. In a second embodiment, a handover partner is determined on the basis of the premise that a handover partner candidate does not interrupt a task under execution.

Since a handover partner takes over a handover target task after completing a task which is being executed by itself, the time required for movement to an execution place of the interrupt task (the time required for return to the interrupt task) which is calculated using Expression 3 in the additional time is 0. Accordingly, it is possible to shorten the additional time and to complete the handover target task for a shorter time.

That is, in the second embodiment, in Step S606 illustrated in FIG. 6, the time required for movement to the execution place of the handover target task and the time required for execution for the handover target task are summed to calculate the additional time, and a handover partner candidate with the shortest additional time is determined as a handover partner.

A time at which the handover target task is handed over to the handover partner and execution thereof starts may be calculated and displayed in the screens illustrated in FIGS. 7A to 7C. The time at which the handover target task is handed over and execution thereof starts is calculated as follows. First, a time required for the handover partner to complete a task which is being executed up to then is calculated using Expression 4.

Time required for completion of task=task quantity×(1−progress)/task execution speed of handover partner (Expression 4)

Then, the time required for completion of the task is added to the start time 404 of the task to calculate the time at which the handover target task is handed over and execution thereof starts.

A situation in which the second embodiment can be effectively applied will be described below. Cases which are effective even when the start time of execution of a handover target task according to the present embodiment is later than that in the first embodiment (cases in which efficiency is considered to be higher than that when the execution start of the handover target task is later) includes the followings.

A first case is a case in which the task will be completed soon. A second case is a case in which a time period in which a task is executable is limited and execution of the task is delayed, for example, by several hours when the time period is missed. A third case is a case in which a target area of the task is congested except for a predetermined time period and thus execution of the task is not efficient when the predetermined time period is missed.

A fourth case is a case in which a robot participates in a task requiring a larger number of robots than a predetermined number. The tasks mentioned in the aforementioned four cases are all tasks which are currently executed by handover partner candidates.

When a task which is currently executed by a handover partner candidate corresponds to the aforementioned cases, the additional time is calculated on the basis of the premise that the task which is currently executed by the handover partner candidate is not interrupted as described above in the present embodiment. When the task which is currently executed by a handover partner candidate does not correspond to the aforementioned cases, the additional time is calculated on the basis of the premise that the task which is currently executed by the handover partner candidate is interrupted.

### Third Embodiment

In the second embodiment, the additional time is calculated on the basis of the premise that the task which is currently executed by a handover partner candidate is not interrupted. On the other hand, in a third embodiment, when the priority of a handover target task is high, a handover partner candidate that can complete the handover target task as early as possible is determined as a handover partner. Accordingly, it is possible to complete the handover target task with a high priority as early as possible.

In the third embodiment, a priority for each task is additionally stored and managed in the task table 400 illustrated in FIG. 4. In the third embodiment, in Step S604 illustrated in FIG. 6, the CPU 201 acquires a priority of a handover target task from the task table 400 using the handover target task information acquiring unit 302.

In Step S606, when the priority of the handover target task is equal to or greater than a predetermined value, the CPU 201 calculates a sum of a time required for movement to an execution place of the handover target task and a time required for execution of the handover target task. A handover partner candidate with the smallest sum is determined as a handover partner.

That is, when the priority of the handover target task is equal to or greater than the predetermined value, the time required for the second device to return to the execution place of the second task is not added to the additional time. On the other hand, when the priority of the handover target task is not equal to or greater than the predetermined value, a handover partner candidate with the smallest sum of Expressions 1 to 3 is determined as a handover partner in the same way as in the first embodiment.

### Fourth Embodiment

In the first embodiment, a handover partner is determined for each of all the handover partner candidates. On the other hand, in a fourth embodiment, the handover partner candidates are narrowed in advance on the basis of predetermined conditions. Accordingly, it is possible to decrease the number of handover partner candidates of which the additional time needs to be calculated and to shorten a calculation time.

A first example of the predetermined conditions is a narrowing condition in which a handover partner candidate has a capability required for execution of a handover target task. In this example, a capability required for execution of a task for each task is additionally stored and managed in the task table 400 illustrated in FIG. 4.

Examples of the capability include movement on a step, opening/closing of a hinged door, opening/closing of a sliding door, sweeping cleaning, and rubbing cleaning. A capability required for execution of a task for each robot is additionally stored and managed in the robot information table 500 illustrated in FIG. 5.

In the fourth embodiment, in Step S604 illustrated in FIG. 6, the CPU 201 acquires a capability required for execution of a handover target task from the task table 400 using the handover target task information acquiring unit 302.

In Step S605 illustrated in FIG. 6, the CPU 201 acquires a capability of a handover partner candidate required for execution of a task from the robot information table 500 using the handover partner candidate information acquiring unit 303. Immediately after Step S605, a handover partner candidate not having the capability required for execution of the handover target task is excluded.

The capability of a robot required for execution of a task may be conditional. For example, a certain robot may have capability A required for execution of a task with a condition of replacement of parts installed therein.

Since the robot has capability A required for execution of a task on the basis of the premise that parts are replaced, it is thought that an additional time is required for satisfying the condition when the capability required for execution of the task is conditional. Accordingly, when a handover partner candidate has a capability for executing a handover target task and the capability is conditional, the handover partner candidate is excluded.

A second example is a narrowing condition in which supplementation of resources is unnecessary while a handover target task is handed over and executed. In this example, a remaining resource quantity and a resource consuming speed (a resource quantity consumed per unit time) for each robot are additionally stored and managed in the robot information table 500 illustrated in FIG. 5.

The remaining resource quantity and the resource consuming speed may be additionally managed for each type of resources. Examples of the resources requiring supplementation of resources include at least a remaining charging capacity, a remaining detergent quantity, and an available capacity of a garbage container. Types of resources consumed in execution of a task for each task are additionally stored and managed in the task table 400 illustrated in FIG. 4.

In Step S604 illustrated in FIG. 6, the CPU 201 additionally acquires types of resources consumed in execution of a handover target task from the task table 400. In Step S605 illustrated in FIG. 6, the CPU 201 additionally acquires a remaining resource quantity and a resource consuming speed of a handover partner candidate from the robot information table 500.

Immediately after Step S605, a resource quantity for each resource consumed in execution of the handover target task is calculated using Expression 5, and a handover partner candidate of which the consumed resource quantity is greater than the remaining resource quantity is excluded.

Consumed resource quantity=resource consumption time*resource consuming speed (Expression 5)

Here, the resource consumption time is a time required for an action of a robot in which resources are consumed and includes a time required for movement to an execution place of a handover target task, a time required for execution of the handover target task, and a time required for movement to an execution place of an interrupt task.

A third example is a narrowing condition in which constraint conditions of an environment in which a handover partner candidate executes a handover target task are satisfied. For example, a robot with a width equal to or larger than that of a passage included in a target area of a task cannot pass along the passage with a predetermined width or hinders passing of a person or another robot and thus is excluded.

When a withstanding load is set in a floor included in a target area of a task and a sum of a weight of a robot and a weight of a load is greater than the withstanding load of the floor, the robot is excluded. In this example, attributes for comparison with the constraint conditions of the environment for each robot are additionally stored and managed in the robot information table 500 illustrated in FIG. 5.

Examples of the attributes include a physique (size) and a weight of a robot and a weight of a load. The constraint conditions of the environment are managed in an environment constraint condition table which is not illustrated. The constraint conditions of the environment include geometrical information and a withstanding load of a floor.

In this way, in the present embodiment, it is determined whether a candidate for the second device satisfies at least one of three conditions described below. The three conditions include a condition in which a candidate for the second device has a capability for executing the first task, a condition in which constraint conditions of an environment in which the first task is executed are satisfied, and a condition in which supplementation of resources is unnecessary while the first task is being executed. In the present embodiment, the second device is determined out of candidates for the second device satisfying at least one of the three conditions.

In Step S605 illustrated in FIG. 6, the CPU 201 additionally acquires attributes of robots from the robot information table 500. Immediately after Step S605, environment constraint conditions are acquired from an environment constraint condition table and compared with the attributes of the robots acquired in Step S605, and a handover partner candidate not satisfying the constraint conditions of the environment in which the handover target task is executed is excluded.

### Fifth Embodiment

In the first embodiment, a handover partner is determined when a handover target task occurs. In a fifth embodiment, execution statuses of tasks are displayed on a screen. Accordingly, a user of the information processing device 200 can ascertain that a handover partner is determined and a handover target task is handed over and executed by the handover partner when the handover target task occurs.

In the fifth embodiment, a task status display unit is additionally connected to, for example, the task execution managing unit 305 in the functional configurations described above with reference to FIG. 3. The task status display unit displays execution status of tasks on the display unit 205. When a handover partner is determined by the handover partner determining unit 304, the screen is updated to display that the handover target task is handed over to the handover partner.

FIGS. 7A to 7C are diagrams illustrating examples of a screen 700 of an information processing device according to the fifth embodiment. FIG. 7A illustrates an example of the screen when all robots operate normally. Reference sign 701 denotes an area in which information on tasks is displayed and the information on tasks is displayed in the form of a table. One row of the table corresponds to one piece of “information on tasks.”

Character strings for uniquely identifying tasks are displayed in the column of a task name 702. In this column, the task IDs 401 of the task table 400 are displayed. A character string for uniquely identifying a robot taking charge of a corresponding task is displayed in the column of a charge 703. In this column, the robot information IDs 501 of the robot information table 500 are displayed.

Execution statuses of tasks are displayed in the column of a status 704. “In execution” is displayed when a task is being executed by a robot, “inexecutable” is displayed when the task cannot continue to be executed, and “interrupt” is displayed when execution of a task which has been originally executed by the robot is interrupted by handover of a task.

FIG. 7B is a diagram illustrating an example of the screen when a robot with a robot ID “Robot_1” breaks down and a handover target task occurs.

“Inexecutable” is displayed in the status 704 of the task which has been taken charge of by the robot with a robot ID “Robot_1.”

FIG. 7C is a diagram illustrating an example of the screen after a robot with a robot ID “Robot_2” has been determined as a handover partner.

Regarding the task (the first row “Task_1” in 701) which has been taken charge of by the robot with a robot ID “Robot_1,” “Robot_2” is displayed in the charge 703, and “in execution” is displayed in the status 704. Regarding the task (the second row “Task_2” in 701) which has been taken charge of by the robot with a robot ID “Robot_2,” “interrupt” is displayed in the status 704.

### Modified Example 1

In the fifth embodiment, execution statuses of tasks are displayed in the screen, and a result of determination of a handover partner may be additionally displayed. Accordingly, a user can ascertain whether a handover partner is determined using a valid method.

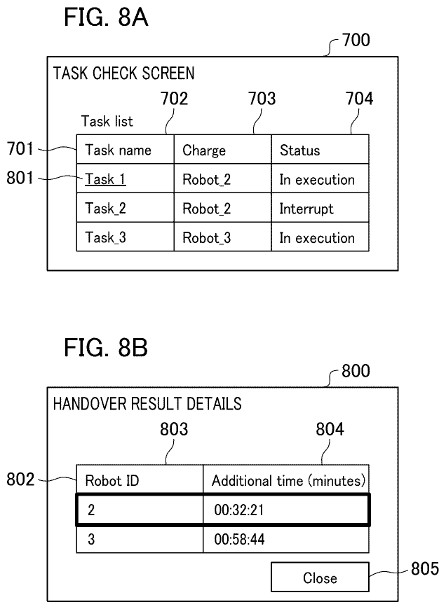

FIGS. 8A and 8B are diagrams illustrating examples of a screen when a result of determination of a handover partner is additionally displayed in the screen illustrated in FIGS. 7A to 7C. Reference signs 700 to 704 are the same as the corresponding reference signs in FIGS. 7A to 7C, and thus description thereof will be omitted. FIG. 8A is a diagram illustrating an example of the screen after a robot with a robot ID “Robot 2” has been determined as a handover partner.

Reference sign 801 denotes a task ID of a handover target task, and the task ID of the handover target task is, for example, underlined to indicate that it can be clicked. When the task ID 801 of the handover target task is clicked, a screen 800 representing details of the handover result is displayed as illustrated in FIG. 8B.

FIG. 8B is a diagram illustrating an example of the screen 800 which is a handover result details screen, and an additional time calculated for each handover partner candidate is displayed at the time of determination of a handover partner. Reference sign 802 denotes an area in which the additional time for each handover partner candidate is displayed.

In the screen 800, additional times for handover partner candidates are displayed in the form of a table. One row in the table corresponds to an “additional time of one handover partner candidate.” The rows can be changed and arranged in the ascending order of the additional times which will be described later. In the screen 800 according to the present embodiment, a row including the smallest additional time is emphasized.

In the column of the robot ID 803, a character string for uniquely identifying a robot is displayed. In this column, the robot information IDs 501 in the robot information table 500 are displayed. Reference sign 804 denotes a column of an additional time, and reference sign 805 denotes a button for closing the handover result details screen. When the button 805 is clicked, the handover result details screen is closed.

### Modified Example 2

In the fifth embodiment, execution statuses of tasks are displayed on the screen, and execution states of robots may be displayed together. Accordingly, it is possible to easily find a robot in a state in which it cannot execute a task.

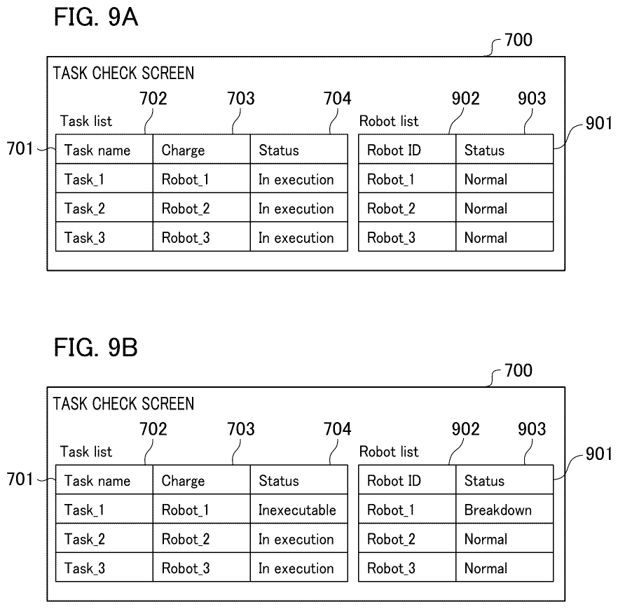

FIGS. 9A and 9B are diagrams illustrating examples of a screen in which execution states of robots are also displayed on the screen illustrated in FIGS. 7A to 7C and illustrates examples of the screen 700 which is displayed on the display unit 205. Reference signs 700 to 704 are the same as the corresponding reference signs in FIGS. 7A to 7C, and thus description thereof will be omitted.

FIG. 9A illustrates an example of the screen when all robots operate normally, and reference sign 901 is an area in which a “robot list” is displayed and information on robots is displayed in the form of a table. One row in the table corresponds to one piece of “information on robots.”

In the column of a robot ID 902, character strings for uniquely identifying the robots are displayed. In this column, the robot information IDs 501 in the robot information table 500 are displayed. States of the robots are displayed in a status 903. “Normal” is displayed when a corresponding robot operates normally, and “breakdown,” “error,” “resource insufficiency,” “task mismatch,” and the like are displayed according to reasons when the corresponding robot cannot execute a task due to some reasons.

FIG. 9B is a diagram illustrating an example of the screen when a robot with a robot ID “Robot_1” breaks down and a handover target task occurs, and “breakdown” is displayed in the status 903 of the robot with a robot ID “Robot_1.”

### Modified Example 3

In the fifth embodiment, execution statuses of tasks are displayed in the screen, and a scheduled completion time of a handover target task when the handover target task is handed over to a handover partner and then executed may be displayed. Accordingly, it is possible to ascertain an influence on the progress of a handover target task when handover occurs.

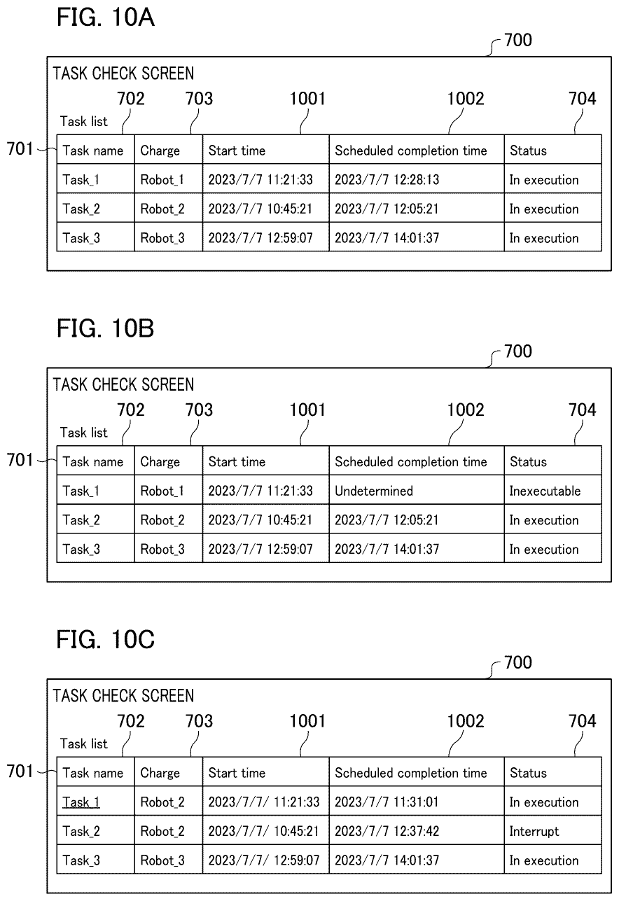

FIGS. 10A to 10C are diagrams illustrating examples of a screen in which a scheduled completion time of a handover target task is also displayed on the screen illustrated in FIGS. 7A to 7C and illustrate examples of the screen 700 displayed on the display unit 205. Reference signs 700 to 704 are the same as the corresponding reference signs in FIGS. 7A to 7C, and thus description thereof will be omitted.

FIG. 10A illustrates an example of the screen when all robots operate normally, and a time at which execution of a task has started is displayed in the column of a start time 1001. That is, the start time 404 in the task table 400 is displayed in this column.

A time at which execution of a task is scheduled to be completed is displayed in the column of a scheduled completion time 1002. The time at which execution of a task is scheduled to be completed is calculated by Expression 6, for example, using the start time 404 and the task quantity 403 of a task and the task execution speed 503 of a robot in charge of the task.

Scheduled completion time of execution of task=start time+task quantity/task execution speed (Expression 6)

FIG. 10B is a diagram illustrating an example of the screen when a robot with a robot ID “Robot_1” breaks down and a handover target task occurs. In FIG. 10B, “inexecutable” is displayed in the task status 704 taken charge of by the robot with a robot ID “Robot_1,” and “undetermined” is displayed in the scheduled completion time 1002.

FIG. 10C is a diagram illustrating an example of the screen after a robot with a robot ID “Robot_2” has been determined as a handover partner.

Regarding the task (the first row “Task_1” in 701) which has been taken charge of by the robot with a robot ID “Robot_1,” “Robot_2” is displayed in the charge 703, and “in execution” is displayed in the status 704. A time which is calculated using Expressions 7 to 9 is displayed in the scheduled completion time 1002.

Scheduled completion time=original completion time−time in which handover source completes remaining part of task+time in which handover partner completes remaining part of task (Expression 7)

Time in which handover source completes remaining part of task =task quantity of handover target task*(1−progress of handover target task)/task execution speed of handover source (Expression 8)

Time in which handover partner completes remaining part of task=time required for handover partner to move to execution place of handover target task+time required for handover partner to execute handover target task (Expression 9)

Regarding a task (the second row “Task_2” in 701) which has been taken charge of by a robot with a robot ID “Robot_2,” “interrupt” is displayed in the status 704, and a time obtained by adding the additional time to the original scheduled completion time is displayed in the scheduled completion time 1002.

### Sixth Embodiment

In the first embodiment, the moving speed or the task execution speed of a robot has a fixed value for each robot. On the other hand, in a sixth embodiment, the moving speed or the task execution speed of a robot varies according to a situation of the robot itself, a surrounding situation of the robot, and the type of the task. Accordingly, it is possible to more accurately calculate the additional time.

In the sixth embodiment, information indicating a situation of a robot for each robot is additionally stored and managed in the robot information table 500 illustrated in FIG. 5. Examples of the situation of a robot include a load of the robot, an aging status of the robot, and a remaining charging capacity. A type of a task for each task may be additionally stored and managed in the task table 400 illustrated in FIG. 4.

In the sixth embodiment, in Step S604 illustrated in FIG. 6, the CPU 201 acquires a type of a handover target task with reference to the task table 400 in addition to details described above in the first embodiment using the handover target task information acquiring unit 302.

In Step S605 illustrated in FIG. 6, the CPU 201 acquires the information indicating the situation of a robot corresponding to each handover partner candidate with reference to the robot information table 500 in addition to details described above in the first embodiment using the handover partner candidate information acquiring unit 303.

The surrounding environment is acquired using an environment information acquiring unit which is not illustrated. The environment information acquiring unit is a functional unit configured to acquire information on an environment in which a robot executes a task. An example of the information on the environment in which a task is executed is road conditions in a target area of the task.

Then, the moving speed or the task execution speed of the robot are acquired with reference to a predetermined lookup table (not illustrated) using the information on the environment in which the task is executed or the situation of the robot and the type of the task.

The handover partner determining unit 304 refers to the moving speed or the task execution speed of the robot which have been acquired in advance at the time of determination of a handover partner, and the task execution managing unit 305 causes the handover partner to operate at the moving speed or the task execution speed of the robot which have been acquired in advance. Accordingly, it is possible to more accurately calculate the additional time.

In this way, in the present embodiment, at least one of information indicating that the first task is a handover target, the additional time for each candidate for the second device, and the second device to which the first task is handed over is displayed on the display unit. Accordingly, a user of the information processing device 200 can easily ascertain a task handover status.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device or the like through a network or various storage media. Then, a computer (or a CPU, an MPU, or the like) of the information processing device or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-001644, filed on Jan. 10, 2024, which is hereby incorporated by reference herein in its entirety.

What is claimed is:

1. An information processing device that determines a second device which takes over execution of a first task from a first device for executing the first task and which executes a second task different from the first task, the information processing device comprising:
one or more memories storing instructions; and
one or more processors executing the instructions to:
detect that the first task is a handover target;
acquire handover target task information on the first task;
acquire handover partner candidate information on candidates for the second device;
acquire an additional time required for executing the first task when the first task is handed over and executed for each candidate for the second device on the basis of the handover target task information and the handover partner candidate information; and
determine the second device to which the first task is handed over out of the candidates for the second device on the basis of the additional times.

2. The information processing device according to claim 1, wherein the additional time includes a time required for the second device to move to an execution place of the first task and a time required for the second device to execute the first task.

3. The information processing device according to claim 1, wherein the additional time includes a sum of a time required for the second device to move to an execution place of the first task, a time required for the second device to execute the first task, and a time required for the second device to return to an execution place of the second task.

4. The information processing device according to claim 3, wherein the time required for the second device to return to the execution place of the second task is not included in the additional time when a priority of the first task is equal to or greater than a predetermined value.

5. The information processing device according to claim 1, wherein a candidate for the second device in which the calculated additional time is shorter is more likely to be determined as the second device when the handover partner candidate information is acquired and the second device is determined out of the candidates for the second device.

6. The information processing device according to claim 1, wherein the second device is determined out of candidates for the second device satisfying at least one of conditions in which: when the candidates for the second device are determined,
the candidates for the second device have a capability of executing the first task;
the candidates for the second device satisfy constraint conditions of an environment in which the first task is executed; and
the candidates for the second device do not require supplementation of resources while executing the first task.

7. The information processing device according to claim 1, wherein at least one of information indicating that the first task is the handover target, the additional time for each candidate for the second device, and the second device to which the first task is handed over is displayed on a display unit.

8. An information processing method of determining a second device which takes over execution of a first task from a first device for executing the first task and which executes a second task different from the first task, the information processing method comprising:
detecting that the first task is a handover target;
acquiring handover target task information on the first task;
acquiring handover partner candidate information on candidates for the second device;
acquiring an additional time required for executing the first task when the first task is handed over and executed for each candidate for the second device on the basis of the handover target task information and the handover partner candidate information; and
determining the second device to which the first task is handed over out of the candidates for the second device on the basis of the additional times.

9. A non-transitory computer-readable storage medium storing a computer program including instructions for executing following processes:
detecting that the first task is a handover target;
acquiring handover target task information on the first task;
acquiring handover partner candidate information on candidates for the second device;
acquiring an additional time required for executing the first task when the first task is handed over and executed for each candidate for the second device on the basis of the handover target task information and the handover partner candidate information; and
determining the second device to which the first task is handed over out of the candidates for the second device on the basis of the additional times.
